(19) United States
(12) Patent Application Publication
(10) Pub. No.: US 2026/0311668 A1
(43) Pub. Date: Oct. 8, 2026

(54) METHOD FOR PRODUCING A SOUND WITH A MUSICAL INSTRUMENT AND MUSICAL INSTRUMENT

(71) Applicant: KORG GERMANY GMBH, Berlin (DE)

(72) Inventors: Lukas Fionnbharr HARTMANN, Berlin (DE); Iarla Brendan SCAIFE, Berlin (DE); Maximilian REST, Berlin (DE); Tatsuya TAKAHASHI, Berlin (DE)

(21) Appl. No.: 19/482,540

(22) PCT Filed: May 3, 2024
(86) PCT No.: PCT/EP2024/062224

§ 371 Date: Nov. 7, 2025

(30) Foreign Application Priority Data
May 8, 2023 (EP) 23172126.7

(51) Int. Cl. G10H 3/18; G10H 3/10; G10H 3/16; G10H 3/20

(52) U.S. Cl. CPC G10H 3/182; G10H 3/10; G10H 3/16; G10H 3/20; G10H 2220/461

(57) ABSTRACT

The present disclosure relates to a method for producing a sound with a musical instrument or for preparing a musical instrument for the production of a sound, wherein the musical instrument comprises a body for being actuated to vibrate, a first deflection sensor at a first position for measuring a deflection of the body at the first position and producing a first signal representing the deflection of the body at the first position, and a second deflection sensor at a second position for measuring a deflection of the body at the second position and producing a second signal representing the deflection of the body at the second position, wherein the musical instrument is configured to produce a sound on the basis of the first and the second signal.

### CROSS REFERENCE TO RELATED APPLICATIONS

This application is a national stage application of PCT/EP2024/062224, filed on May 3, 2024, which claims the benefit of and priority to European Patent Application No. 23172126.7, filed on May 8, 2023, the entire contents of each of which are incorporated herein by reference in their entirety to the same extent as if fully set forth herein.

### TECHNICAL FIELD

The invention relates to a method for producing a sound with a musical instrument or for preparing a musical instrument for the production of a sound, wherein the musical instrument comprises a body for being actuated to vibrate, a first deflection sensor at a first position for measuring a deflection of the body at the first position and producing a first signal representing the deflection of the body at the first position, and a second deflection sensor at a second position for measuring a deflection of the body at the second position and producing a second signal representing the deflection of the body at the second position, wherein the musical instrument is configured to produce a sound on the basis of the first and the second signal. The invention also relates to such a musical instrument.

### BACKGROUND

It is desired in many technical applications to sense the movement of a body in space to further process this information. Especially in musical applications, movement is sensed with pickups to output a signal proportional to this movement for further use, typically to produce a sound.

Movement of physical bodies often comprises a superposition of many different distinct and discrete frequencies. A special case of movement is resonance, which is the oscillating natural response of a body in space to external stimulation by an impulse or continuous signal. The frequency content in this natural response is then dominated by the modes of resonance. Modes of resonance depend on the geometry and material of the body, the surrounding environment and other internal and external constraints and properties.

When applying a uniform pickup across a specific area of the moving body in space, averaging effects can cancel out the contributions of certain modes to the output signal of the pickup. Especially in musical applications, a mode-selective pickup can be desired to increase the performance of the pickup and/or shape the spectrum of the sensed movement signal.

### SUMMARY

It is an object of the invention to provide for a mode selective production of sound with a musical instrument, wherein the selection of modes is highly flexible and yet simple to achieve.

The object is achieved by a method according to claim 1.

In particular, a) the method comprises selecting a first target mode of vibration of the body to be emphasized in the sound, wherein the musical instrument is configured either a1) such that in the first target mode of vibration at a given point in time the body comprises a positive deflection with respect to the first deflection sensor and a positive deflection with respect to the second deflection sensor and such that the sound is produced on the basis of a sum of the first signal and the second signal; or a2) such that in the first target mode of vibration at a given point in time the body comprises a positive deflection with respect to the first deflection sensor and a negative deflection with respect to the second deflection sensor and such that the sound is produced on the basis of a difference of the first signal and the second signal.

Additionally or alternatively, b) the method comprises selecting a second target mode of vibration of the body to be deemphasized in the sound, wherein the musical instrument is configured either b1) such that in the second target mode of vibration at a given point in time the body comprises a positive deflection with respect to the first deflection sensor and a positive deflection with respect to the second deflection sensor and such that the sound is produced on the basis of a difference of the first signal and the second signal; or b2) such that in the second target mode of vibration at a given point in time the body comprises a positive deflection with respect to the first deflection sensor and a negative deflection with respect to the second deflection sensor and such that the sound is produced on the basis of a sum of the first signal and the second signal.

This method provides for a high flexibility in amplifying one mode over another one. In particular, with just one deflection sensor at a certain position-for comparison -only limited sets of modes being amplified with respect to each other are possible. With the method of the invention, it is possible to simply select the target mode or modes and select the positions and choice of summing or differential amplifier accordingly.

The term “mode” generally refers to an order of resonant vibration of the body. The numbering of the first and second target mode is arbitrary and does not necessarily refer to the first and second order of resonant vibration. In general, the simplest form of resonant vibration or “fundamental” will be referred to herein as mode 0. Higher order modes are numbered accordingly.

The method presented here describes a novel and advantageous technique for a mode-selective pickup scheme to sense movement of a body in space. By applying sensing, such as capacitive sensing, around local areas of peak deflection of a certain mode of the moving body, the relative amplitude of that mode compared to that of other modes can be maximized. This effectively shapes the spectrum of the output signal without additional external components.

The first and the second signal or any other signals may be weighted. Thereby, further desired effects can be achieved and emphasis or deemphasis of modes can be further facilitated.

In general, as far as the musical instrument is configured in the specified manner, this can entail switching or otherwise adjusting the musical instrument accordingly. For example, configuring the musical instrument may comprise positioning the first and/or the second deflection sensor, in particular along the body, and/or establishing or activating a connection of a line of the first signal and a line of the second signal with a summing or differential amplifier, the output of which is basis for the sound to be produced. Said lines may be wires and/or conductors of the respective signals.

The musical instrument may generally be configured by a person playing the musical instrument or by a person or system preparing the musical instrument. Preparing the musical instrument may comprise manufacturing of the musical instrument or adjusting the musical instrument after manufacture.

Preferably, the first and the second position are spaced apart along an axis that is perpendicular to the axis of the measured deflection at the first and/or the second position. Also, the first and the second deflection sensor are preferably spaced apart along the body.

In a preferred embodiment, the first and/or the second position are arranged at or near a peak of deflection of the first or the second target mode. This provides for an even improved emphasis or deemphasis of the respective mode in the sound. According to a further embodiment, the first and the second deflection sensors are arranged on the same side of the body, in particular with respect to the direction of deflection. This provides for a simple yet selective setup.

The musical instrument may comprise a first opposing deflection sensor arranged oppositely to the first deflection sensor, the body being arranged between the first deflection sensor and the first opposing deflection sensor, wherein the first signal is produced on the basis of a difference between the deflection of the body with respect to the first deflection sensor and the deflection of the body with respect to the first opposing deflection sensor. This further improves the sound production. In particular, this provides for cancellation and/or reduction of both common mode noise and distortion. The term distortion relates to the fact, that most sensors, in particular capacitive sensors, comprise non-linear areas of operation, especially in extreme areas. For example, a capacitive sensor typically comprises an anti-proportional relationship between the distance of the electrodes and the output signal. However, if the same sensor type is used on both opposing sides, such non-proportionality can be cancelled out, due to an essentially inverse arrangement of the opposing sensors.

Also and with a similar beneficial effect, the musical instrument may comprise a second opposing deflection sensor arranged oppositely to the second deflection sensor, the body being arranged between the second deflection sensor and the second opposing deflection sensor, wherein the second signal is produced on the basis of a difference between the deflection of the body with respect to the second deflection sensor and the deflection of the body with respect to the second opposing deflection sensor.

Multiple opposing and/or adjacent deflection sensors can advantageously be designed into the sound production scheme. Differential processing of adjacent and/or opposing sensors can further increase signal-to-noise ratio due to cancellation of common mode noise and allow for more advanced spectral shaping. Distortion cancellation and/or reduction is another advantage of opposing sensors.

According to an embodiment, the musical instrument comprises a third deflection sensor at a third position for measuring a deflection of the body at the third position, wherein the first signal is produced on the basis of a sum of signals representing the deflection of the body with respect to the first and third deflection sensors or wherein the second signal is produced on the basis of a sum of signals representing the deflection of the body with respect to the second and third deflection sensors. The third deflection sensor provides for a further improved emphasis or deemphasis of the respective target mode. The first and third or the second and third deflection sensors, respectively, are preferably arranged spaced apart at least essentially by the wavelength or an integer multiple of the wavelength of the respective target mode.

In fact, any number of deflection sensors can be used. The deflection sensors can be positioned and their signals can be fed positively or negatively into a sound production unit as needed in order to produce a sound with emphasis and/or deemphasis of target modes. For example, an array of deflection sensors could be used.

In a preferred embodiment, the deflection sensors are capacitive sensors. Such sensors are based on the electrostatic effect and are simple in construction and precise in their output.

Further possible and advantageous types of deflection sensors include contactless, magnetic, inductive, optical, piezoelectric, dielectric and/or air pressure sensors.

According to a preferred embodiment, the body is a metal body. In general, and also advantageously, however, the body may be made of or comprise wood, plastic, glass and/or a composite material.

In general, the body may also be a fluid, such as air or water. In such cases, the deflection sensors may be configured as pressure sensors. A wind instrument, such as a flute, is an example of a musical instrument with a vibrating body, that is a fluid, in that case air.

The body may also be a drum body, for example.

In the case of the body being a conductive metal body, capacitive, i.e. electrostatic, pickup techniques are highly advantageous to sense the movement of the body, since the body itself can be used as an electrode of a capacitor used for the measurement. Electrostatic pickups are based on measuring the change of capacitance between two conductive surfaces which form a capacitor with a voltage applied across. The capacitance between these two surfaces depends on their geometry, area, distance, surrounding materials and other constraints. Preferably, a fixed plate or electrode forms one part of the capacitor, wherein the moving body forms the other.

The body is preferably an elongate body. Advantageous embodiments of the body are a string, a reed, a tine, a rod or a plate. Other geometrical shapes are possible.

In further embodiments, the body may be an at least two-prong body and/or be fork-shaped. This provides for a simple and yet precise tuning of the body as needed. Alternatively or additionally, the body is in particular a resonating body.

In case, the body is fork-shaped, the first target mode and/or the second target mode may preferably be a common mode or a differential mode of vibration. Common mode refers to a synchronous oscillation of the two prongs and differential mode refers to an alternating oscillation of the two prongs.

Preferably, the musical instrument is a keyboard instrument, an electric piano, a synthesizer, a drum synthesizer and/or a sound effect unit. Another possible and generally advantageous example of a musical instrument is a plucked string instrument, such as an electric guitar. Also, the musical instrument may be a drum machine or an effects unit.

The object of the invention is also achieved by a musical instrument for the production of a sound according to the independent claim directed thereto. The musical instrument comprises a body for being actuated to vibrate, a first deflection sensor at a first position for measuring a deflection of the body at the first position and producing a first signal representing the deflection of the body at the first position, and a second deflection sensor at a second position for measuring a deflection of the body at the second position and producing a second signal representing the deflection of the body at the second position.

The musical instrument may further comprise a) a mode selection arrangement for selecting a first target mode to be emphasized in the sound, wherein if the first target mode is selected, the musical instrument and/or the mode selection arrangement is configured either a1) such that in the first target mode of vibration at a given point in time the body comprises a positive deflection with respect to the first deflection sensor and a positive deflection with respect to the second deflection sensor and such that the sound is produced on the basis of a sum of the first signal and the second signal; or a2) such that in the first target mode of vibration at a given point in time the body comprises a positive deflection with respect to the first deflection sensor and a negative deflection with respect to the second deflection sensor and such that the sound is produced on the basis of a difference of the first signal and the second signal.

Alternatively or additionally, the musical instrument may comprise b) a mode selection arrangement for selecting a second target mode to be deemphasized in the sound, wherein if the second target mode is selected, the musical instrument and/or the mode selection arrangement is configured either b1) such that in the second target mode of vibration at a given point in time the body comprises a positive deflection with respect to the first deflection sensor and a positive deflection with respect to the second deflection sensor and such that the sound is produced on the basis of a difference of the first signal and the second signal; or b2) such that in the second target mode of vibration at a given point in time the body comprises a positive deflection with respect to the first deflection sensor and a negative deflection with respect to the second deflection sensor and such that the sound is produced on the basis of a sum of the first signal and the second signal.

The mentioned mode selection arrangements may comprise the same elements or may in fact be the same device, providing for selection of both the first and the second target modes.

Any embodiment and/or feature described herein with regard to a method or a musical instrument of the invention may be employed to improve another method or musical instrument of the invention described herein.

### BRIEF DESCRIPTION OF THE DRAWINGS

In the following, further examples are described with reference to the attached drawings:

FIG. 1 illustrates a setup with two deflection sensors measuring the deflection of a string body.

FIG. 2 illustrates a setup with four deflection sensors measuring the deflection of a reed body.

FIG. 3 illustrates various setups with deflection sensors measuring the deflection of respective prongs of a fork body.

FIG. 4 illustrates an arrangement of a body, configured as a string and multiple deflection sensors.

### DETAILED DESCRIPTION

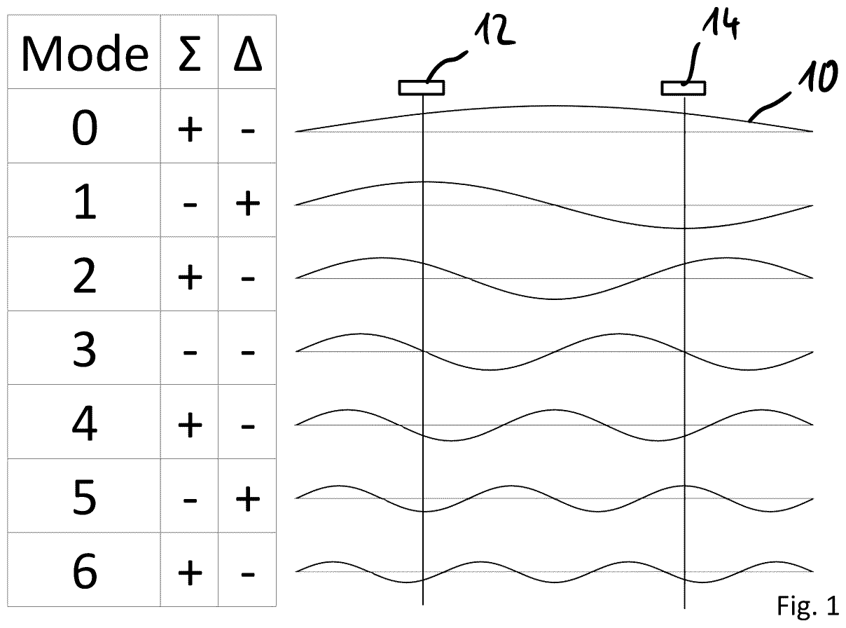

In FIG. 1, a body 10, which is a string in this embodiment, is depicted in different modes of vibration. The simplest form of vibration or fundamental is referred to as mode 0 in the depicted table. Higher modes are numbered accordingly.

FIG. 1 also depicts a first deflection sensor 12 and a second deflection sensor 14 arranged in the vicinity of the body 10. With respect to mode 0, the first deflection sensor 12 will produce a positive output signal, while second deflection sensor 14 will produce a positive output signal. With respect to mode 1, the first deflection sensor 12 will produce a positive output signal, while the second deflection sensor 14 will produce a negative output signal. The output signals for the further modes will be apparent from FIG. 1.

A sound can be produced on the basis of both the output signals of the first and the second deflection sensors 12, 14. Different modes can be emphasized or deemphasized dependent upon whether the sound is produced on the basis of a sum of the output signals or on the basis of a difference of the output signals. The table of FIG. 1 indicates the respective results. Σ refers to a summation of the output signals of the first and the second deflection sensors 12, 14. A refers to a difference of the output signals of the first and the second deflection sensors 12, 14. + indicates an emphasis of the respective mode. − indicates a deemphasis of the respective mode.

As an example in accordance with a method of the invention, mode 1 could be selected as a first target mode to be emphasized and/or mode 3 could be selected as a second target mode to be deemphasized and this could be achieved by producing the sound on the basis of a sum (Σ) of the output signals of the first and the second deflection sensors 12, 14. As a further example in accordance with a method of the invention, mode 2 could be selected as a first target mode to be emphasized and/or mode 1 could be selected as a second target mode to be deemphasized and this could be achieved by producing a sound on the basis of a difference (Δ) of the output signals of the first and the second deflection sensors 12, 14. Further possibilities of emphasizing and deemphasizing certain modes will be apparent from FIG. 1 and the table depicted therein.

While the above description referring to FIG. 1 presumes the positions of the first and second deflection sensors 12, 14 to be fixed, emphasizing and/or deemphasizing certain modes may also be facilitated by positioning the first and second deflection sensors 12, 14 in accordance with the methods described herein. In particular, it is advantageous to position the first and second deflection sensors 12, 14 near or at peaks of deflection of the body for a specific mode, especially if that mode is to be emphasized. If a mode is to be deemphasized, it may also be advantageous to position the first and second deflection sensors 12, 14 at or near positions of 0 deflection of the body 10, as is, for example, the case in FIG. 1 at mode 3.

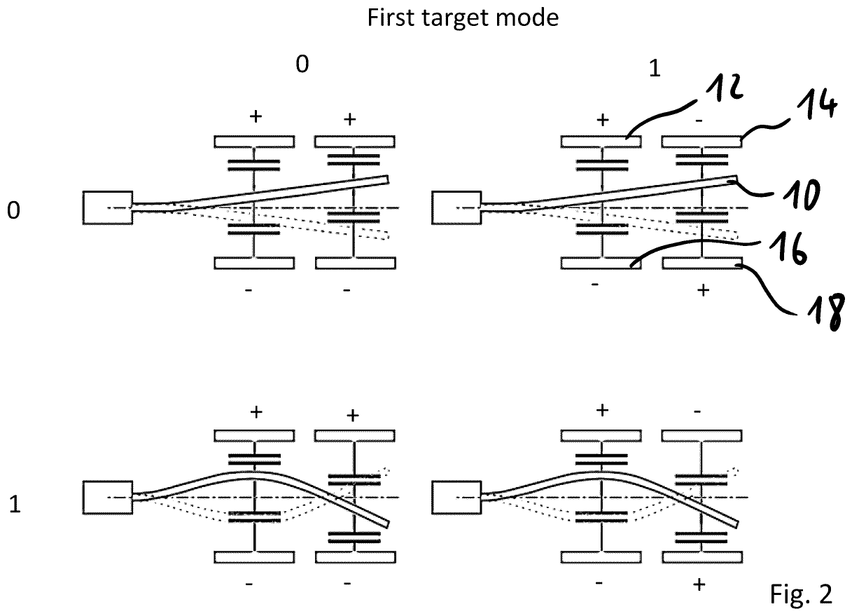

In FIG. 2, a body 10 is configured as a reed and depicted in a mode 0 and a mode 1 of vibration. In the first row, mode 0 is depicted. In the second row, mode 1 is depicted. Both modes 0 and 1 are depicted twice to illustrate different sensor setups in accordance with selection of mode 0 or mode 1, respectively, as first target mode, i.e. the mode to be emphasized.

Each depicted setup comprises a first deflection sensor 12, a second deflection sensor 14, a first opposing deflection sensor 16, arranged oppositely to the first deflection sensor 12, and a second opposing deflection sensor 18, arranged oppositely to the second deflection sensor 14.

Next to each deflection sensor, a + or a − sign, respectively, indicates a sign with which the signal of the respective deflection sensor is fed into a sound production unit (not shown). The signals of deflection sensors 12, 14, 16, 18 are referred to as S12, S14, S16, S18, respectively.

If the first target mode is mode 0, i.e. if mode 0 is to be emphasized, the signals can be combined as indicated in the left column of FIG. 2, i.e. in the two left hand drawings. In particular, the signals are combined as follows: +S12+S14−S16−S18=Output. At mode 0 and as a qualitative calculation, this results in +(+1)+(+1)−(−1)−(−1)=4. At mode 1 and as a qualitative calculation, this results in +(+1)+(−1)−(−1)−(+1)=0. Thus, in this setup mode 1 is deemphasized. Different variants of the combination are possible, such as (S12+S14)−(S16+S18)=Output or (S12−S16)+(S14−S18)=Output.

If the first target mode is mode 1, i.e. if mode 1 is to be emphasized, the signals can be combined as indicated in the right column of FIG. 2, i.e. in the two right hand drawings. In particular, the signals are combined as follows: +S12−S14−S16+S18=Output. At mode 0 and as a qualitative calculation, this results in +(+1)−(+1)−(−1)+(−1)=0. At mode 1 and as a qualitative calculation, this results in +(+1)−(−1)−(−1)+(+1)=4. Thus, in this setup mode 0 is deemphasized. Different variants of the combination are possible, such as (S12−S14)+(S18−S16)=Output or (S12+S18)−(S14+S16)=Output.

Again, it becomes apparent that with the methods of the invention certain modes can easily and yet effectively be emphasized or deemphasized at the choice of the musician or the manufacturer of the musical instrument.

The methods of the invention can generally be applied to one-dimensional or multidimensional detection of movement, depending on the position and geometry of the sensors around the vibrating body and the geometry of the vibrating body itself.

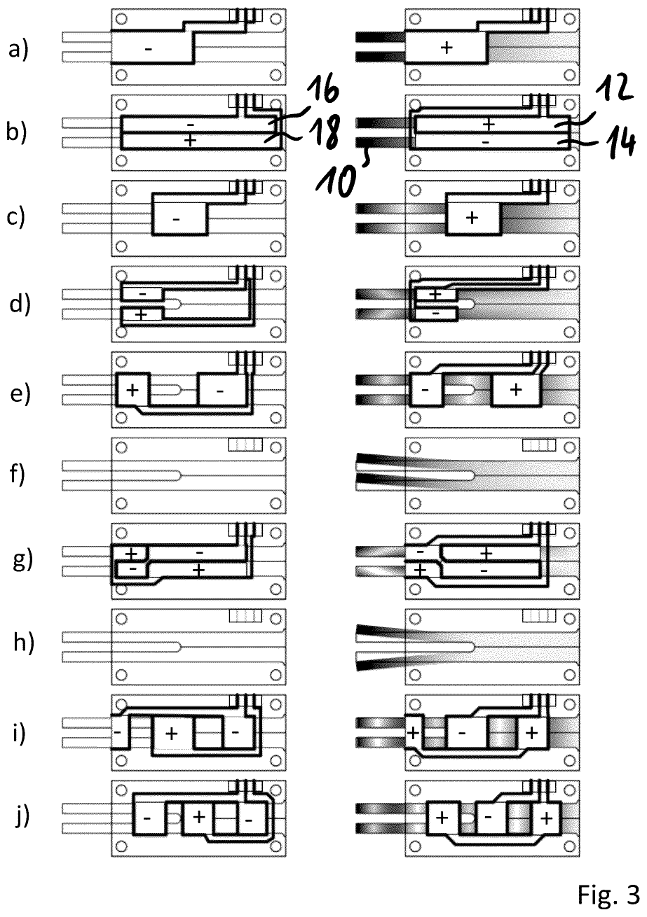

In FIG. 3, different sensor setups and different modes of vibration are depicted for an exemplary embodiment of a fork-shaped body 10, which is only referenced once in FIG. 3 for the purpose of clarity. A + or − sign is positioned at a respective plate of a capacitive deflection sensor and indicates whether the output of the deflection sensor is negatively or positively fed into the sound production unit (not shown). The left column shows a top part of the body 10 and the respective sensor setup, while the right column shows a bottom part. In fact, the choices of top and bottom are arbitrary and merely illustrate that opposing sides of the body 10 and sensor setups are shown. Only in the right column, a deflection of the prongs of the fork body 10 is indicated in grayscale.

FIG. 3 a) depicts a sensor setup with a first deflection sensor, a first opposing deflection sensor and a body in common mode vibration.

FIG. 3 b) depicts a sensor setup with two deflection sensors 12, 14 and two opposing deflection sensors 16, 18 wherein the body 10 is vibrating in a differential mode.

FIG. 3 c) depicts a sensor setup with a first deflection sensor, a first opposing deflection sensor and a common mode vibration of the body 10.

FIG. 3 d) depicts a sensor setup with two deflection sensors on each side of the body, wherein the body 10 is vibrating in a differential mode.

FIG. 3 e) depicts a sensor setup with two deflection sensors spaced apart along the body 10 and with two opposing deflection sensors on the other side of the body 10, wherein the body 10 is vibrating in a common mode.

FIG. 3 f) depicts the body 10 vibrating in a lateral common mode, i.e. the prongs are deflected laterally and synchronously. A sensor setup is not shown here. Any of the other described sensor setups could be used to sense the shown type of vibration.

FIG. 3 g) depicts a sensor setup with four deflection sensors on each side of the body 10. The body 10 is vibrating in a differential mode. The sensors or sensor plates on the same side of the body with the same sign are directly connected to each other.

FIG. 3 h) depicts the body 10 vibrating in a further lateral mode, which is a differential mode. A sensor setup is not shown here. Any of the other described sensor setups could be used to sense the shown type of vibration.

FIG. 3 i) depicts a sensor setup with three deflection sensors on each side of the body 10. The sensors or sensor plates on the same side of the body 10 with the same sign are directly connected to each other. The body 10 is vibrating in a common mode.

FIG. 3 j) depicts a sensor setup with three deflection sensors on each side of the body 10. The sensors or sensor plates on the same side of the body with the same sign are directly connected to each other. The body 10 is vibrating in a common mode.

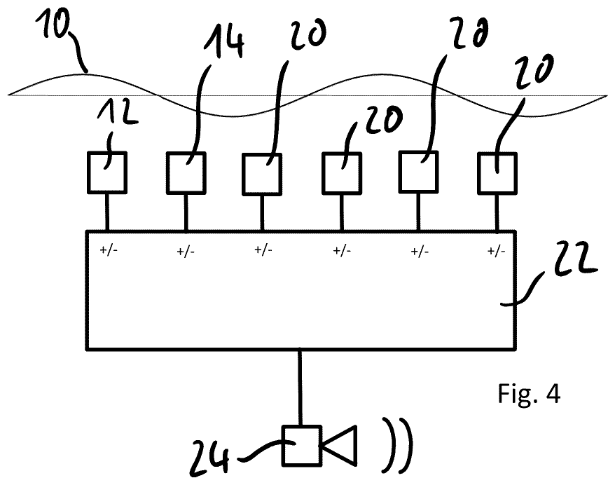

FIG. 4 shows an arrangement of a body 10, configured as a string in this example, and multiple deflection sensors positioned along the body 10. In particular, the arrangement comprises a first deflection sensor 12, a second deflection sensor 14 and further deflection sensors 20. The output signals of the deflection sensors 12, 14, 20 are fed into a mode selection arrangement 22, with which a musician can select target modes to be emphasized or deemphasized. The mode selection arrangement feeds the signals from the deflection sensors 12, 14, 20 accordingly, i.e. positively or negatively, optionally with a weighting coefficient, in accordance with the desired emphasis or deemphasis of modes, into a sound production unit 24.

### LIST OF REFERENCES

10 body
12 first deflection sensor
14 second deflection sensor
16 first opposing deflection sensor
18 second opposing deflection sensor
20 deflection sensor
22 mode selection arrangement
24 sound production unit

1. A method for producing a sound with a musical instrument or for preparing a musical instrument for the production of a sound, wherein the musical instrument comprises:
a body for being actuated to vibrate;
a first deflection sensor at a first position for measuring a deflection of the body at the first position and producing a first signal representing the deflection of the body at the first position; and
a second deflection sensor at a second position for measuring a deflection of the body at the second position and producing a second signal representing the deflection of the body at the second position,
wherein the musical instrument is configured to produce a sound on a basis of the first and the second signal,
wherein the method comprises selecting a first target mode of vibration of the body to be emphasized in the sound, wherein the musical instrument is configured either:
a1) such that in the first target mode of vibration at a given point in time the body comprises a positive deflection with respect to the first deflection sensor and a positive deflection with respect to the second deflection sensor and such that the sound is produced on a basis of a sum of the first signal and the second signal; or
a2) such that in the first target mode of vibration at a given point in time the body comprises a positive deflection with respect to the first deflection sensor and a negative deflection with respect to the second deflection sensor and such that the sound is produced on a basis of a difference of the first signal and the second signal;
and/or
wherein the method comprises selecting a second target mode of vibration of the body to be deemphasized in the sound, wherein the musical instrument is configured either:
b1) such that in the second target mode of vibration at a given point in time the body comprises a positive deflection with respect to the first deflection sensor and a positive deflection with respect to the second deflection sensor and such that the sound is produced on a basis of a difference of the first signal and the second signal; or
b2) such that in the second target mode of vibration at a given point in time the body comprises a positive deflection with respect to the first deflection sensor and a negative deflection with respect to the second deflection sensor and such that the sound is produced on a basis of a sum of the first signal and the second signal.

2. The method according to claim 1, wherein configuring the musical instrument comprises positioning the first and/or the second deflection sensor and/or establishing or activating a connection of a line of the first signal and a line of the second signal with a summing or differential amplifier, an output of which is basis for the sound to be produced.

3. The method according to claim 1, wherein the first and the second position are spaced apart along an axis that is perpendicular to an axis of the measured deflection at the first and/or the second position.

4. The method according to claim 1, wherein the first and/or the second position are arranged at or near a peak of deflection of the first or the second target mode.

5. The method according to claim 1, wherein the first and the second deflection sensors are arranged on a same side of the body

6. The method according to claim 1,
wherein the musical instrument comprises a first opposing deflection sensor arranged oppositely to the first deflection sensor, the body being arranged between the first deflection sensor and the first opposing deflection sensor, and
wherein the first signal is produced on a basis of a difference between the deflection of the body with respect to the first deflection sensor and the deflection of the body with respect to the first opposing deflection sensor.

7. The method according to claim 1,
wherein the musical instrument comprises a second opposing deflection sensor arranged oppositely to the second deflection sensor the body being arranged between the second deflection sensor and the second opposing deflection sensor and
wherein the second signal is produced on a basis of a difference between the deflection of the body with respect to the second deflection sensor and the deflection of the body with respect to the second opposing deflection sensor.

8. The method according to claim 1,
wherein the musical instrument comprises a third deflection sensor at a third position for measuring a deflection of the body at the third position,
wherein the first signal is produced on a basis of a sum of signals representing the deflection of the body with respect to the first and third deflection sensors, or
wherein the second signal is produced on a basis of a sum of signals representing the deflection of the body with respect to the second and third deflection sensors.

9. The method according to claim 1, wherein the deflection sensors are capacitive sensors.

10. The method according to claim 1, wherein the body is a metal body.

11. The method according to claim 1, wherein the body is a string, a reed, a tine, a rod or a plate.

12. The method according to claim 1, wherein the body is an at least two-prong body and/or is fork-shaped and/or wherein the body is a resonating body.

13. The method according to claim 1, wherein the body is fork-shaped and the first target mode and/or the second target mode is a common mode or a differential mode of vibration.

14. The method according to claim 1, wherein the musical instrument is a keyboard instrument, an electric piano, a synthesizer, a drum synthesizer and/or a sound effect unit.

15. A musical instrument for production of a sound, comprising:
a body for being actuated to vibrate;
a first deflection sensor at a first position for measuring a deflection of the body at the first position and producing a first signal representing the deflection of the body at the first position,
a second deflection sensor at a second position for measuring a deflection of the body at the second position and producing a second signal representing the deflection of the body at the second position, and
a) a mode selection arrangement for selecting a first target mode to be emphasized in the sound,
wherein if the first target mode is selected, the musical instrument and/or the mode selection arrangement is configured either:
a1) such that in the first target mode of vibration at a given point in time the body comprises a positive deflection with respect to the first deflection sensor and a positive deflection with respect to the second deflection sensor and such that the sound is produced on a basis of a sum of the first signal and the second signal; or
a2) such that in the first target mode of vibration at a given point in time the body comprises a positive deflection with respect to the first deflection sensor and a negative deflection with respect to the second deflection sensor and such that the sound is produced on a basis of a difference of the first signal and the second signal; and/or
b) a mode selection arrangement for selecting a second target mode to be deemphasized in the sound,
wherein if the second target mode is selected, the musical instrument and/or the mode selection arrangement is configured either:
b1) such that in the second target mode of vibration at a given point in time the body comprises a positive deflection with respect to the first deflection sensor and a positive deflection with respect to the second deflection sensor and such that the sound is produced on a basis of a difference of the first signal and the second signal; or
b2) such that in the second target mode of vibration at a given point in time the body comprises a positive deflection with respect to the first deflection sensor and a negative deflection with respect to the second deflection sensor and such that the sound is produced on a basis of a sum of the first signal and the second signal.
